(19) United States
(12) Patent Application Publication
(10) Pub. No.: US 2024/0024801 A1
(43) Pub. Date: Jan. 25, 2024

(54) SAND SEPARATION CONTROL SYSTEM AND METHOD

(71) Applicant: ENERCORP ENGINEERED SOLUTIONS INC., Calgary (CA)

(72) Inventors: Brent James William Coombe, Calgary (CA); Ryan Thomas Bowley, Calgary (CA); Rory Nagge, Calgary (CA); Tien Nguyen, Calgary (CA); Anthony Alaniz, Calgary (CA); Brandon Mayberry, Calgary (CA)

(21) Appl. No.: 18/338,944

(22) Filed: Jun. 21, 2023

Related U.S. Application Data
(63) Continuation-in-part of application No. 17/513,333, filed on Oct. 28, 2021, now Pat. No. 11,707,702.
Application No. 17/513,333 is a continuation of application No. 17/096,490, filed on Nov. 12, 2020, now Pat. No. 11,577,184.
(60) Provisional application No. 62/957,585, filed on Jan. 6, 2020.

(51) Int. Cl. B01D 21/30; B01D 21/26; B01D 21/24; G01F 23/00; G01M 3/28; E21B 43/34; G01G 19/00

(52) U.S. Cl. CPC B01D 21/302; B01D 21/267; B01D 21/245; G01F 23/0007; G01M 3/2876; E21B 43/35; G01G 19/00; E21B 43/267

(57) ABSTRACT

A sand separation systems and method for operating a sand separation system, of which the method includes separating sand from a fluid using a plurality of separators. A plurality of manifold valves are each coupled to a respective one of the separators. The method includes selecting one of the separators to blowdown, signaling to one of the manifold valves coupled to the selected separator for the manifold valve to open, opening the manifold valve, signaling a blowdown unit to execute a blowdown, opening a valve of the blowdown unit in response to the signaling, receiving sand from the selected separator into a sand disposal unit through the open manifold valve and the blowdown unit, and measuring the sand using a sensor of the separator, a load cell of the sand disposal unit, or both.

### CROSS-REFERENCE TO RELATED APPLICATIONS

This application is a continuation-in-part of U.S. patent application Ser. No. 17/513,333, which was filed on Oct. 28, 2021 and is a continuation of U.S. patent application Ser. No. 17/096,490, which was filed on Nov. 12, 2020, and claims priority to U.S. Provisional Patent Application Ser. No. 62/957,585, which was filed on Jan. 6, 2020. Each of these applications is incorporated herein by reference in its entirety.

### BACKGROUND

Hydraulic fracturing is a well-treatment process in which preferential flowpaths for hydrocarbons are established in a subterranean rock formation. The flowpaths are established by pumping a fluid at high pressure into a well to initiate fractures in the rock formation. The fracturing fluid may be predominately water, but may also include solids, such as sand or ceramic proppants, which at least partially fill the fractures and keep the fractures open, maintaining the preferential flowpaths through the rock after the process is complete.

When oil, water, or other fluids are produced/recovered from the well, it may be desirable to remove sand or other solids from the fluid. A separator system may be used for this purpose, and may include one or more separation devices (e.g., cyclonic separators), filters, screens, tanks, etc. The separated solids may be stored in the tank, which is periodically emptied or “blown down,” while the fluids may be further separated (e.g., to separate hydrocarbons from water). Recovered hydrocarbons may be stored or otherwise transported for sale, and recovered water may be stored or otherwise recirculated for use in the well.

In some cases, it may be desirable to determine the amount of solids separated from the fluid in the separator, and/or the rate at which solids accumulate in the tank. In order to do this, the solids from the separator may be run through a “sock” dining blowdown operations, which may catch the solids while allowing the fluid to flow through. The sock is then weighed, which reveals the amount of solids collected therein between blowdown operations. However, such a manual process exposes operations to worker-related delays and calls for the sock to be removed and weighed after each blowdown, which can be time and labor intensive. Moreover, the manual) processes are not well-suited to managing blowdown operations in multi-separator and/or multi-well systems.

### SUMMARY

Embodiments of the disclosure include a method for operating a sand separation system. The method includes separating sand from a fluid using a plurality of separators, the separators each temporarily storing the sand therein, and a plurality of manifold valves each being coupled to a respective one of the separators, selecting, using a control unit, one of the plurality of separators to blowdown, signaling, from the control unit, to one of the manifold valves, the one of the manifold valves being coupled to the selected one of the plurality of separators, for the one of the manifold valves to open, opening the one of the manifold valves, wherein the other manifold valves remain closed, signaling, from the control unit to a blowdown unit, for the blowdown unit to execute a blowdown, opening one or more valves of the blowdown unit in response to the signaling, so as to blowdown the selected one of the separators, receiving the sand from the selected one of the separators into a sand disposal unit, the sand passing through the manifold valve that is opened and through the blowdown unit, and measuring the sand that was separated in the one of the separators using a sensor of the one of the separators, a load cell of the sand disposal unit, or both.

Embodiments of the disclosure include a sand separation system. The system includes a plurality of separators in fluid communication with one or more wells and configured to receive a mixture comprising sand and fluid therefrom, and to separate at least some of the sand from the fluid, the separators temporarily storing the sand that is separated from the fluid, a blowdown unit including a blowdown valve assembly in communication with the separators, the blowdown valve assembly being configured to be opened to permit the sand stored in the separator to exit the separator, a manifold valve assembly positioned between the plurality of separators and the blowdown unit, the manifold valve assembly being configured to control which of the separators is in fluid communication with the blowdown valve assembly, a sand disposal unit configured to receive the sand that is stored in the separators between blowdown operations, and a control system in communication with the blowdown unit, the sand disposal unit, and the manifold valve assembly, the control system being configured to initiate the blowdown operations by opening one of the manifold valves and opening the blowdown valve assembly, so as to blowdown a selected one of the plurality of separators.

### BRIEF DESCRIPTION OF THE DRAWINGS

The present disclosure may best be understood by referring to the following description and the accompanying drawings that are used to illustrate embodiments of the invention. In the drawings:

FIG. 1 illustrates a schematic view of a sand separation system, according to an embodiment.

FIG. 2 illustrates a schematic view of a well and a separator of the sand separation system, according to an embodiment.

FIG. 3A illustrates a schematic view of a blowdown unit of the sand separation system, according to an embodiment.

FIG. 3B illustrates a schematic view of another embodiment of the blowdown unit.

FIG. 4 illustrates a schematic view of a sand disposal unit of the sand separation system, according to an embodiment.

FIG. 5 illustrates a schematic view of a central controller of the sand separation system, according to an embodiment.

FIG. 6 illustrates a flowchart of a method for blowdown and leak detection/mitigation to assist in automatically controlling a sand separation system, according to an embodiment.

FIG. 7 illustrates a flowchart of a method for automatically controlling a sand separation system, according to an embodiment.

FIG. 8 illustrates a schematic view of a sand separation system, according to an embodiment.

FIG. 9 illustrates a schematic view of a sand separation system, according to an embodiment.

FIG. 10 illustrates a side, cross-sectional view of a separator of any one of the foregoing systems, according to an embodiment.

FIGS. 11A, 11B, 11C, and 11D illustrate side, schematic views of an accumulator for a separator, which may be provided with an external sand-level detector, according to an embodiment.

FIGS. 12A and 12B illustrate a flowchart of a method for operating a sand separation system, according to an embodiment.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

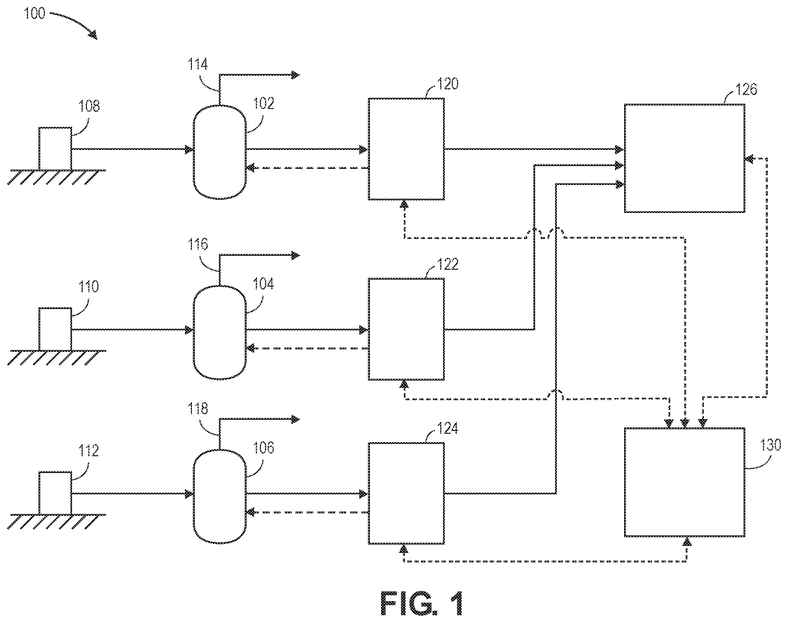

FIG. 1 illustrates a schematic view of a sand separation system 100, according to an embodiment. The system 100 is described herein in terms of separating sand, but it will be appreciated that in some contexts, “sand” may refer to particulate matter of various types, including, for example, ceramic proppant and the like, which may be injected and recovered from a well. The system 100 may include one or more separators (three shown: 102, 104, 106), which may each be coupled to and configured to receive a mixture of sand and fluids from a well 108, 110, 112, respectively. In the illustrated embodiment, one separator 102-106 is provided for each individual well 108-112, but it will be appreciated that in other embodiments, a single separator 102-106 may receive fluid from two or more wells 108-112 and/or two or more separators 102-106 may receive fluid from a single well 108-112.

The separators 102-106 may be configured to separate at least a portion of the sand from the fluids produced from the wells 108-112. The separated fluid may be routed through an outlet 114, 116, 118 of each separator 102-106 and delivered, e.g., to a production separator or another device or location. The sand, along with some of the fluid, that is separated from the mixture, may be temporarily stored in the separator 102-106. For example, the separators 102-106 may each provide a hopper, or another type of pressurized tank, which may, during normal operation, fill with the sand as it is separated. Before the sand entirely fills the separator 102-106, it may be removed therefrom, i.e., a “blowdown” process is executed.

Accordingly, the system 100 may include one or more blowdown units (three are shown: 120, 122, 124). For example, one blowdown unit 120-124 may be provided for each separator 114-116; however, it will be appreciated that this one-to-one configuration is merely an example, and two or more blowdown units 120-124 could be used for a single separator 102-106 and/or a single one of the blowdown units 120-124 could be provided for two or more of the separators 102-106. As will be described in greater detail below, the blowdown units 120-124 may include, among other things, one or more valves that are actuatable to control blowdown of the separators 102-106 associated therewith. Further, as indicated by the dashed lines between the blowdown units 120-124 and the separators 102-106, the blowdown units 120-124 may be configured to communicate with the separators 102-104. For example, the separators 102-106 may be provided with various chokes and/or pressure transducers, which may provide electrical data and/or control signals to the blowdown unit 120-124.

When the blowdown units 120-124 initiate a blowdown procedure, one or more valves therein, which are in fluidic communication with the separators 102-106, are opened, allowing the sand (e.g., as a slurry of sand and fluid) to flow out of the separators 102-106, through the blowdown units 120-124, and into a sand disposal unit 126. In some embodiments, the sand disposal unit 126 may include a sand quantification feature, which may be configured to provide data representing an amount of sand that was stored in the separator 102-106 between blowdowns. For example, the sand disposal unit 126 may provide the sand quantification feature using load cells, e.g., as disclosed in U.S. Provisional Patent Application No. 62/930,175, which is incorporated herein by reference in its entirety. In other embodiments, such a sand quantification feature may be provided within the separator 102-106 itself. For example, the separators 102-106 may include load cells, such as the separators described in U.S. Provisional Patent Publication No. 2019/0388907, which is incorporated herein by reference in its entirety, to the extent not inconsistent with the disclosure herein. In another embodiment, the separators 102-106 may include other types of sensors that are able to detect an amount of sand that is in the separators 102-106, e.g., as described in U.S. patent application Ser. No. 16/711,561 and/or U.S. Provisional Patent Application No. 62/946,520, which are both incorporated by reference herein in their entirety, to the extent not inconsistent with the present disclosure.

The system 100 may also include a central controller (or “control system” or “control unit”) 130, which may communicate at least with the blowdown units 120-124. The central controller 130 may also communicate with the sand disposal unit 126, e.g., in cases where the sand disposal unit 126 includes the sand quantification feature. The central controller 130 may be in communication with the blowdown units 120-124 via electric communication and/or the separators 102-106. For example, the central controller 130 may send signals to the blowdown units 120-124 commanding the blowdown units 120-124 to open individual valves thereof, e.g., to initiate or terminate a blowdown procedure, mitigate valve malfunctioning, shutoff blowdown capabilities, etc. Further, the central controller 130 may be configured to receive feedback signals from the blowdown units 120-124, e.g., pressure and/or flow measurements at specific locations therein and/or in the separators 102-106. Additionally, the central controller 130 may include hardware enabling communication with local and/or remote operators, e.g., through a human-machine interface. For example, the central controller 130 may include output devices such as a computer terminal, an antenna for wireless communication, a web portal connection, etc. Additional details relevant to operation of the central controller 130, according to various embodiments, are discussed below.

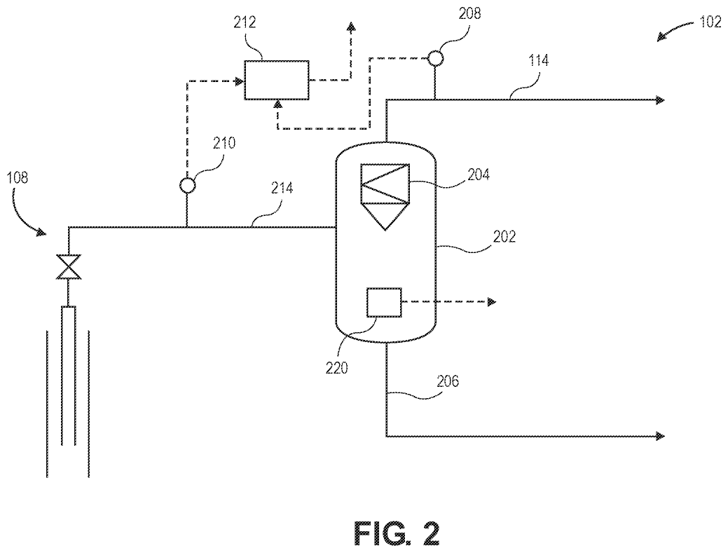

FIG. 2 illustrates a schematic view of the well 108 and the separator 102 of the system 100, according to an embodiment. The separator 102 may also be representative of at least some embodiments of the separators 104 and 106. As shown, the separator 102 includes a cyclonic separator 204 in combination with a tank 202. In some embodiments, the cyclonic separator 204 may be positioned on top of the tank 202, such that the tank 202 supports the weight of the cyclonic separator 200. The tank 202 may receive and temporarily store solids (e.g., sand) separated from the sand/fluid mixture received at an inlet 214 of the separator 200. The tank 202 may also include a blowdown outlet 206. The blowdown outlet 206 may connect to the blowdown unit 120, as noted above, such that the blowdown unit 120 may be considered “downstream” of the blowdown outlet 206, in the sense that fluid flows toward the blowdown unit 120.

The separator 102 may also include one or more pressure transducers (two shown: 208, 210). These transducers (or others) 208, 210 may be in (e.g., electric) communication with a junction 212. The junction 212, in turn, may be in communication with the central controller 130, e.g., via the blowdown unit 120. That is, in at least one embodiment, the junction 212 may serve as an input for the blowdown unit 120, which may send signals as an input to the central controller 130. In other embodiments, the junction 212 may communicate directly with the controller 130 and/or may communicate only with the blowdown unit 120. The pressure transducer 210 may be positioned at an inlet 214 to the separator 102 and may measure pressure in the mixture of fluid and solids received from the well 108. The pressure transducer 208 may be positioned in the outlet 114 and configured to measure the pressure of the separated fluid received therein. Various other pressure transducers may be employed, e.g., to measure pressure-drop between the inlet 214 and the outlet 206 and/or outlet 114 and/or across chokes or other flow control mechanisms.

In at least one embodiment, the separator 102 may include a load cell 220 configured to produce a signal representative of the weight of the sand separated from the incoming fluid by the cyclonic separator 204. As mentioned above, in at least one embodiment, the load cell 220 may be contained at least partially within the tank 202. For example, a sand hopper may be suspended within the tank 202 via a linkage that includes the load cell 220, such that the load cell 220 is configured to measure a weight of the sand without measuring a weight of the tank 202 or the cyclonic separator 204 (or at least a portion of either/both), thereby potentially increasing an accuracy of the weight measurement. At some point, the increasing weight may indicate that the tank 202 is near capacity or otherwise ready to be blown down. In other embodiments, this load cell 220 may be omitted in view of the measurements taken at the sand disposal unit 126, as described herein.

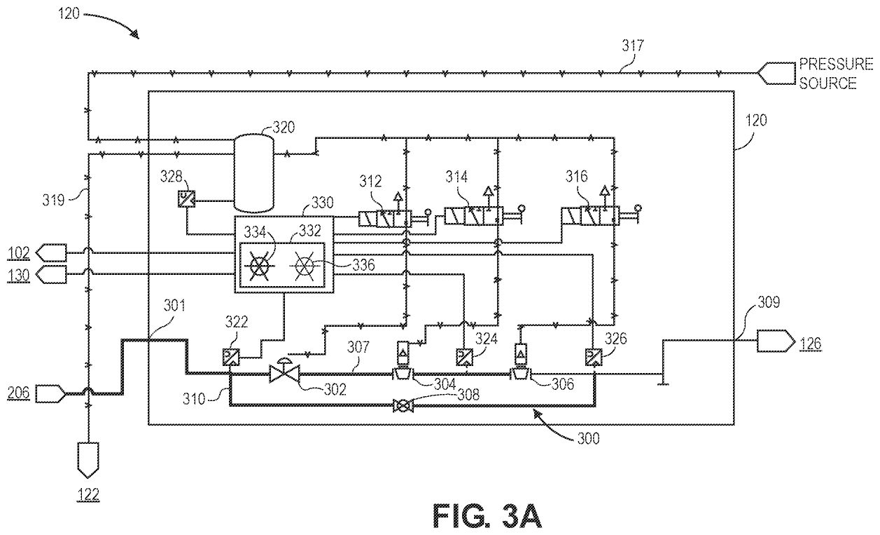

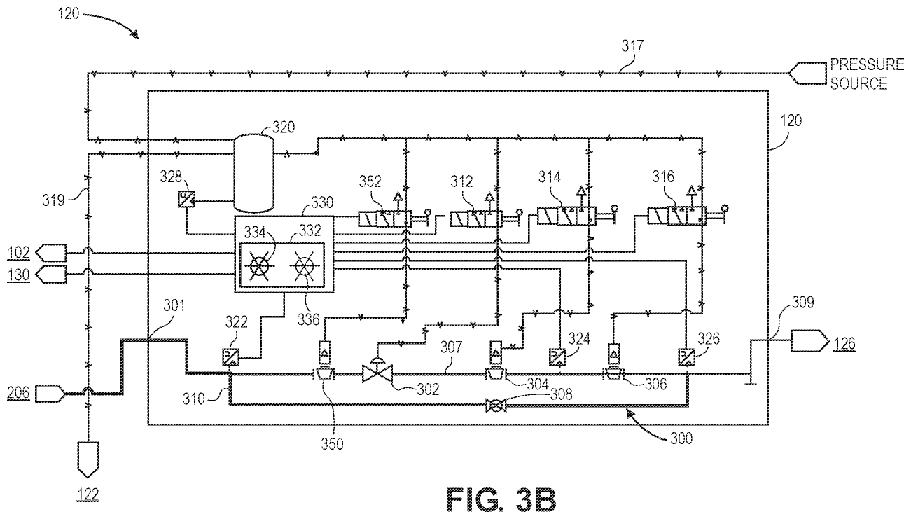

FIG. 3A illustrates a schematic view of the blowdown unit 120, according to an embodiment. The blowdown unit 120 embodiment that is illustrated may also be representative of at least one embodiment of the other blowdown units 122, 124. The blowdown unit 120 may include a blowdown valve assembly 300, which may be coupled to the blowdown outlet 206 of the separator 102 via an inlet 301. The blowdown valve assembly 300 may be configured to initiate, control, and terminate the blowdown procedure for the separator 102.

In an embodiment, the blowdown valve assembly 300 may include a shutdown valve 302, a first valve 304, and a second valve 306. The first and second valves 304, 306 may be plug valves, or any other suitable type of valve. The valves 302-306 may be in series, such that fluid flows through the valves 302-306 sequentially, one after the other, e.g., through a blowdown line 307 that extends from the inlet 301 and connects the valves 302-306 together. For example, the shutdown valve 302 may be the first in the series, with the first valve 304 being downstream therefrom, and the second valve 306 being downstream from the first valve 304. Downstream of the second valve 306, the blowdown line 307 may be connected to an outlet 309, which may be connected to the sand disposal unit 126.

In addition, in some embodiments, the blowdown valve assembly 300 may include a bypass valve 308. The bypass valve 308 may be in parallel with the valves 302-306. For example, a bypass line 310 may connect to the blowdown line 307 upstream of the shutdown valve 302, and then again to the blowdown line 307 downstream of the second valve 306.

The valves 302, 304, 306 may be actuated between open positions (permitting fluid flow therethrough) and closed positions (blocking fluid flow therethrough) via respective control valves 312, 314, 316. The control valves 312, 314, 316 are in turn coupled to a control power source, which in this embodiment, is an accumulator 320 that contains a pressurized gas (e.g., air) received via a pressure line 317. The accumulator 320 may also be coupled with a pressure line 319, which may lead to the accumulator of another one of the blowdown units (e.g., unit 122, as shown). In other embodiments, the control power source could be a battery or another source of electric power, a hydraulic power source, or any other suitable source of power.

The control valves 312, 314, 316 are shown in an open configuration, directing pressure from the accumulator 320 to the individual valves 302, 304, 306. In some embodiments, the first and second valves 304, 306 may be biased to their closed positions. Upon application of the pressure from the accumulator 320 via the control valves 314, 316, the first and second valves 304, 306 may be individually actuated (e.g., lifted) to the open position, thereby permitting flow therethrough in the blowdown line 307. Similarly, the shutdown valve 302 may have its closed position as a default and may be opened by application of pressure from the accumulator 320 via the control valve 312. Actuating the control valves 312, 314, 316 to their closed positions may thus relieve pressure from the accumulator 320 to the valves 302-306, which may cause them to close, or at least attempt to close, to block fluid flow through the blowdown line 307. In some embodiments, the bypass valve 308 may be manually operated or operated using a separate control system. The bypass line 310 may thus normally be closed, and may be employed, e.g., in emergency situations.

The blowdown unit 120 may include one or more pressure transducers. For example, pressure transducers 322, 324, 326 may be positioned to measure pressure in the blowdown line 307. For example, the pressure transducer 322 may be configured to measure pressure from the blowdown outlet 206. In some embodiments, this pressure may be higher when the blowdown line 307 is closed (e.g., one or more of the valves 302-304 are closed) as opposed to when at least partially open. Further, the transducer 324 may measure a pressure in the line 307 between the first and second valves 304, 306. When the first valve 304 is closed, the pressure in the line 307 between the first and second valves 304, 306 may be expected to drop, e.g., to ambient or at least to a pressure that is lower than the pressure at the inlet 301. Similarly, the pressure transducer 326 may be positioned downstream of the second valve 306 and may be expected to read ambient or some other relatively low pressure when the first and/or second valves 302, 304 are closed. When the valves 302-306 are open, pressure measured by the transducers 322-326 may be generally equal. In some embodiments, at least the pressure transducer 326 may be replaced or supplemented with a flow meter, so as to detect fluid flow past the second valve 306 and in the outlet 309.

Another pressure transducer 328 may be coupled to the accumulator 320 or elsewhere in the control side of the blowdown unit 120. The pressure transducer 328 may thus be configured to measure the pressure that is available to actuate the valves 302-306.

The blowdown unit 120 may further include a junction box 330. The junction box 330 may be coupled to the pressure transducers 322-328 and configured to receive electrical signals representing the pressures measured by each. Further, the junction box 330 may be coupled to the control valves 312-316 and may be configured to send a control signal thereto, which may cause the control valves 312-316 to actuate between the open and closed positions. Further, the junction box 330 may include or be coupled to a display panel 332. The display panel 332 may include one or more lights 334, 336, alarms, digital display panels, etc., configured to indicate a status (blowdown procedure underway, blowdown procedure ready, warning, etc.).

FIG. 3B illustrates another embodiment of the blowdown unit 300. In this embodiment, a choke valve 350 may be included to control fluid flow in the line 107. For example, the choke valve 350 may be a cyclonic valve or another type of valve that integrates a choke therein. Such a cyclonic valve may, for example, provide two plates, each with slots or other openings formed therein that may be rotated into or out of alignment. The choke valve 350 may include a variable cross-sectional flowpath area, which may be, at its largest, smaller than the cross-sectional flowpath area of the line 107. As such, even when open, the valve 350 may create a pressure drop in the line 107, which may mitigate or otherwise slow erosion of the valves 302, 304, 306 downstream.

Further, the position of the valve 350 (e.g., open, closed, partially open, or partially closed) may be modulated through the use of a pneumatic control valve 352, which may have two or more positions. In some embodiments, the valve 350 may be the first valve (among valves 350, 304, and 306) to open, and the last of valves 350, 302, 304 to close during normal blowdown operations. As such, the choke valve 350 may experience the highest pressures among the valves 302-306 and 350 of the blowdown valve assembly 300. The choke valve 350 may, in some embodiments, be considered consumable and regularly replaced, and may prevent or at least forestall the other valves 302-306 from similarly being consumed. Alternatively, the valve 350 may be replaced by a fixed-orifice choke, which may likewise induce a pressure drop in the line 107 upstream of the valves 302-306. Further, such an orifice could be placed between or downstream of any/all of the valves 302-306, and embodiments that include multiple orifices are also contemplated herein.

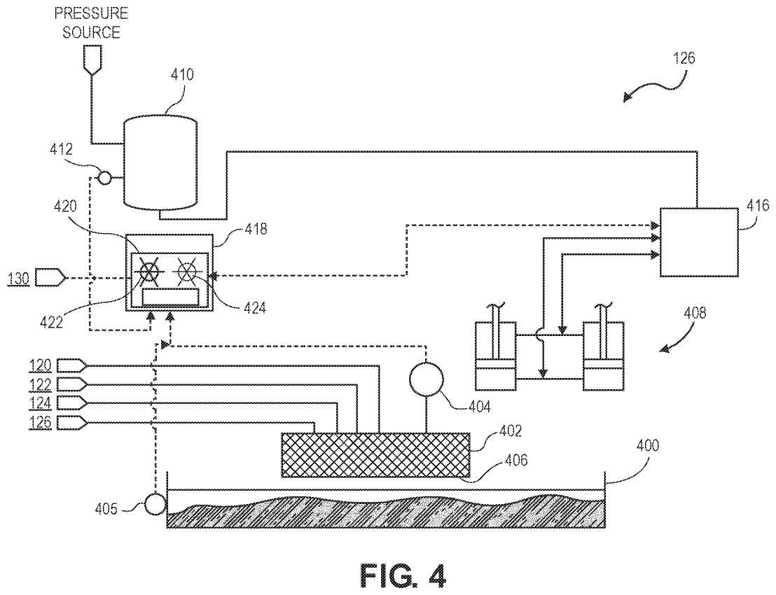

FIG. 4 illustrates a schematic view of the sand disposal unit 126, according to an embodiment. The sand disposal unit 126 may include a disposal container 400, e.g., a tank that may be open to the air and thus at ambient pressure. A basket 402 may be positioned over the container 400 and may be configured to receive sand (and some fluid, e.g., a slurry) from the separators 102-106 via the blowdown units 120-124, as indicated. The basket 402 may include a screen or another type of filter media, such that, when a slurry of sand and fluid is received therein, the fluid drains out of the sand and into the container 400. One or more load cells 404 may be provided to measure a weight of the basket 402, from which the weight of the sand contained therein may be calculated. Further, a level sensor 405 (e.g., a float, viscosity sensor, etc.) may be positioned in the container 400 and configured to measure a level (or at least indicate when the level reaches a certain elevation) of the contents in the container 400.

The basket 402 may include a bottom 406 that is openable via a hydraulic assembly 408 (or any other type of actuator assembly). The hydraulic assembly 408 is shown separate from the basket 402 in this schematic view, but it will be appreciated that the hydraulic assembly 408 may be configured to raise and lower the bottom 406, e.g., pivotally, with respect to a remainder of the basket 402. Thus, the hydraulic assembly 408 may be configured to dump the contents of the basket 402 into the container 400.

In an embodiment, the sand disposal unit 126 may include an accumulator 410, which may be coupled to a source of pressurized gas, e.g., air from a compressor. A pressure transducer 412 may be coupled to the accumulator 410, so as to measure a pressure of the gas contained therein, e.g., to ensure that sufficient pressure is available in the accumulator 410.

An air-over-hydraulic (AOH) system 416 may be provided as part of the sand disposal unit 126. The AOH system 416 may receive pneumatic pressure from the accumulator 410 and may selectively employ the pneumatic pressure to actuate the hydraulic assembly 408 and thereby open and close the bottom 406. Electrical or mechanical hydraulic options are also available for the system 416, and thus an AOH embodiment should be considered merely as an example.

The sand disposal unit 126 may include a junction box 418, which may be in electrical communication with the load cell(s) 404, the level sensor 405, the pressure transducer 412, the AOH system 416, and the central controller 130. The junction box 418 may be operable to receive measurements from the load cell 404, level sensor 405, and the pressure transducer 412, and may transmit these measurements to the central controller 130.

In an embodiment, the level sensor 405 may communicate with the central controller 130 (or any other control system, e.g., a processor on-board the sand disposal unit 126). The level sensor 405 feedback may be used to determine when the tank 400 is nearly full, and shut down blowdowns (and/or shut in the well(s)) to prevent such overfill. The feedback from the level sensor 405 may also serve as a trigger for empty the tank 400. For example, when the level sensor 405 registers that the tank 400 is nearing full (or otherwise reaches a critical level), a vacuum truck may be notified to empty the tank 400. Blowdown and/or other well operations may then recommence. As will be described in greater detail below, the level sensor 405 may also be employed to determine blowdown intervals and/or blowdown duration, potentially in combination with weight measurements from the load cell 404 (and/or 220, FIG. 2).

Further, the junction box 418 may receive commands from the central controller 130. For example, such commands may include opening or closing the bottom 406 of the basket 402. In an embodiment, the junction box 418 may send an electric signal to the AOH system 416, which may actuate one or more valves thereof, causing the AOH system 416 to supply fluid to the hydraulic assembly 408, and thereby open or close the bottom 406.

The junction box 418 may also include a panel 420, including one or more lights (two shown: 422, 424) and a weight indicator. The weight indicator may display a weight, which may be representative of the weight of the sand in the basket 402. The lights 422, 424 may display a status of the sand disposal unit 126, e.g., ready for blowdown, ready for empty, emptying, low pneumatic pressure, warning of malfunction, etc.

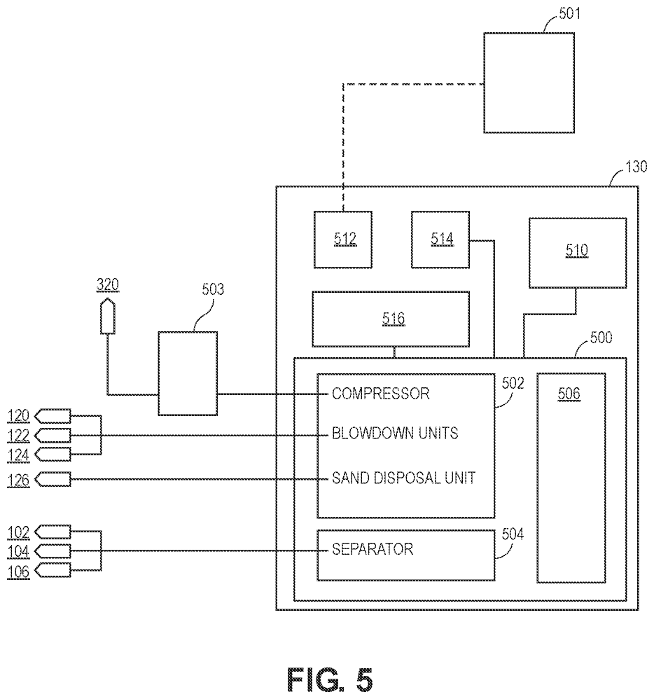

FIG. 5 illustrates a schematic view of the central controller 130, according to an embodiment. In addition to the central controller 130, FIG. 5 also shows a light tower 501 and a compressor 503. The compressor 503 may be coupled to any of the accumulators mentioned above and/or act as a source of pressurized fluid (e.g., air) for any other component of the system 100.

The central controller 130 may include a programmable logic controller (PLC) 500, microprocessor, or any other device(s) capable of executing computer-readable instructions and to cause the various components of the system 100 to perform operations. The PLC 500 may in turn include a blowdown control module 502, a separator control module 504, and a human-machine interface 506. The blowdown control module 502 may include connections for the compressor 503, the blowdown units 120-124, and the sand disposal unit 126. These connections may allow for input and output to/from the PLC 500. For example, via the connection with the compressor 503, the PLC 500 may control the speed, pressure, etc. of the compressor 503. Via the connection with the blowdown units 120-124, the PLC 500 may individually control the blowdown units 120-124, causing the blowdown units 120-124 to perform a blowdown process (e.g., independently of one another). The PLC 500 may also be able receive sensor measurements from the blowdown units 120-124, e.g., to determine whether the blowdown units 120-124 (e.g., the blowdown valve assemblies 300 thereof) are operating properly and/or have sufficient pneumatic pressure in the accumulator 320 to actuate the valves 302-306. Moreover, via the connection with the blowdown units 120-124, the PLC 500 may be configured to open/close individual valves 302-306 of the blowdown units 120-124, e.g., using electric signals.

The PLC 500 may also be configured to communicate with the sand disposal unit 126 via the connection therewith. For example, the PLC 500 may receive sensor measurements therefrom, e.g., the weight of the sand in the basket 402 measured by the load cell(s) 404. The PLC 500 may also be configured to send electric signals to the sand disposal unit 126, e.g., so as to cause the bottom 406 to open or close (e.g., via command through the AOH system 416 and the hydraulic assembly 408).

The PLC 500 may be in communication with the separators 102-106 via the separator control module 504. Using this module 504, the PLC 500 may be able to shutdown operation of the separators 102-106, control flow rates, etc., via direct communication with the separators 102-106, individually, e.g., by actuating one or more valves thereof. For example, one or more shutdown valves may be positioned upstream of the individual separators 102-106, and may be closed to shutdown the separator 102-106, and potentially shut-in the well 108-112 to which it is connected. In some embodiments, the PLC 500 may communicate with the load cell 220 in the sensors 102-106 in lieu of or in addition to communicating with the sand disposal unit 126 to determine the amount of sand expelled during a blowdown.

The PLC 500 may be configured to provide output to and receive input from a local user via the HMI 506. For example, the HMI 506 may provide for a manually-initiated blowdown, a manual dump of the basket 402, a read out of the weight of the sand in the basket 402, calibration (e.g., tare) of the load cell(s) 404, blow down, a counter of the number of times blowdown operations have occurred, and plots of the historical blowdown (e.g., sand accumulation) data.

In addition to the PLC 500, the central controller 130 may include hardware and/or software configured to provide a variety of other functions. For example, the central controller 130 may include a modem 510, which may be configured to broadcast signals to a remote system and/or receive signals therefrom. This may allow for remote communication with the controller 130 and remote control thereof. For example, the modem 510 may be in communication with the PLC 500 so as to communicate data signals therewith.

The controller 130 may further include a light-tower controller 512, which is coupled to the light tower 501 and configured to control the lights thereof. The controller 130 may also include a power source 514, which may be coupled to an external source of power (e.g., a generator or municipal grid), and may be configured to convert AC power to (e.g., 12V or 24V) DC power. The controller 130 may further include a panel showing a status of the controller 130 and/or various components of the system 100, e.g., when blowdown is initiated, detection of a malfunction, etc.

The controller 130 may provide a central control system for the system 100, able to pass along commands and receive sensor measurements, e.g., system-wide. Thus, the controller 130 may enforce a prioritization hierarchy of commands or processes in response to a detected status of the system 100. In a specific example, the prioritization hierarchy may be or include the following:

| Priority | Scenario | Description | Action |
|---|---|---|---|
| 1 | High level tank | Sensor 405 indicates | Shutdown valves 302 closed in |
| | | maximum tank level | each of the blowdown units |
| | | reached. | 120-124. Provide notification to |
| | | | operator/vacuum truck |
| | | | provider. |
| 2 | Critical Leak | Transducer 322 measures a | Shutdown valve 302 closed in |
| | Detected | pressure above a threshold | affected blowdown unit 120- |
| | | and transducer 324 registers | 124. Provide notification to |
| | | flow and/or pressure | operator. |
| 3 | Minor Leak | Transducer 322 reads | Activate leak mitigation routine |
| | Detected | pressure below the critical | and issue minor leak detection |
| | | threshold, but above | notification. If cycle counter is |
| | | another, lower threshold | exceeded, issue minor leak |
| | | and/or transducer 324 | detected alarm. |
| | | register flow and/or | |
| | | pressure below critical | |
| 4 | Blowdown from | Setpoint trigger (e.g., | Perform blowdown and activate |
| | sensor trigger or | weight of separator) | leak detection logic. If multiple |
| | internal scale | received. | calls for blowdown received, |
| | | | blowdown in the order |
| | | | received. |
| 5 | Scheduled | Regularly scheduled | Perform when scheduled and |
| | Blowdown | blowdown time reached. | activate leak detection logic. |

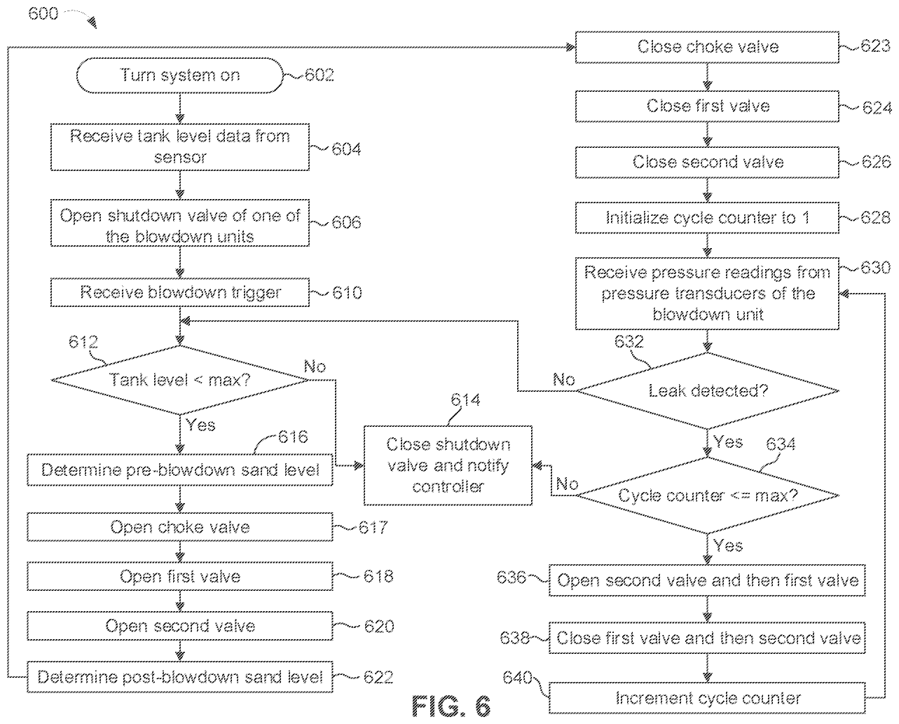

FIG. 6 illustrates a flowchart of a method 600 for blowdown and leak detection/mitigation to assist in automatically controlling a sand separation system, e.g., the sand separation system 100, according to an embodiment. Although a particular order for the steps of the method 600 is described, it will be appreciated that the steps may be executed in a different order and/or steps may be combined or separated.

The method 600 may begin by turning the system on, as at 602. For example, the controller 130 may be energized by closing a relay connect the controller 130 to its power source. Likewise, the blowdown units 120-124 may be powered on, e.g., upon receipt of electrical and/or pneumatic power. The wells 108-112 may also be turned on, e.g., to commence production of fluids therefrom and into the separators 102-106.

The method 600 may then include receive tank level data, e.g. from the sensor 405 regarding the level of sand, water, etc., contained in the container 400, as at 604. Further, the method 600 may include opening the shutdown valve 302 of at least one of the blowdown units 120-124 (e.g., blowdown unit 120), as at 606. At this stage, the first and second valves 304, 306 (and/or the choke valve 350) of the blowdown unit 120 may be or remain closed, thereby preventing blowdown of the corresponding separator 102.

The separator 102 may be operated normally, receiving and separating a mixture of sand or other solids and water or other fluids from a well 108. Eventually, a blowdown trigger may be received, as at 610. The trigger may be based on one or more pressures measured by the transducers 208 and/or 210 (e.g., a differential therebetween) in the separator 102. Additionally or alternatively, the trigger may be the expiration of a timer or reaching a predetermined scheduled time for blowdown of the separator 102.

Prior to initiating blowdown, however, the method 600 may include determining whether the level in the container 400 exceeds a maximum, as at 612, e.g., using the level sensor 405. The maximum may be predetermined or may be dynamic, e.g., varying on how much sand is typically received into the container 400 during a blowdown procedure.

If the container 400 level is at or above its maximum, the shutdown valve 302 may be returned to the closed position, and the controller 130 may be notified, as at 614. The controller 130 may thus take steps to notify rig personnel that the container 400 is full and should be emptied or drained, thereby avoiding unintended overfilling of the container 400. The controller 130 may also, based on this notification, prevent blowdown procedures from being initiated for other separators 102-106 of the system 100.

If the container 400 has capacity (e.g., lower than maximum level), the method 600 may proceed to determining a pre-blowdown sand level, as at 616. This may be determined using the sensor 404 (e.g., load cells attached to the basket 402) and/or the level sensor 405 in the tank 400 but could also or instead be derived by the weight of the separator 102.

The method 600 may then proceed to opening the choke valve 350, as at 617. The method 600 may then proceed to opening the first valve 304, as at 618. After a delay, the second valve 306 may then be opened, as at 620. Accordingly, if the valves 302-306 and 350 are functioning properly, the blowdown unit 120 may thus permit blowdown of the separator 102, such that its contents are emptied into the basket 402 via the blowdown line 307. During or after such blowdown, the sand level may again be determined, as at 622. The differences in the values of sand measured at 616 and 622 may thus be representative of the sand and/or fluids removed from the separator 102 during blowdown.

After a delay sufficient to allow for blowdown of the separator 102 (measured, e.g., from the opening of the second valve 306), i.e., a “blowdown duration”, the method 600 may include closing the choke valve 350 (if provided), as at 623 and then the first valve 304, as at 624. After a delay, e.g., to allow closure of the first valve 304, the method 600 may proceed to closing the second valve 306, as at 626.

At this stage, leakage detection and/or mitigation may be initiated. The method 600 may also include initializing a cycle counter, which may count the number of times valve closure is attempted, to one, as at 628. The method 600 may include receiving pressure measurements from one or more of the pressure transducer(s) (e.g., pressure transducer 324) of the blowdown unit 120, as at 630.

The method 600 may then include determining whether a leak in the valve(s) 304, 306 is apparent, as at 632. For example, if the pressure measurement received from the pressure transducer 324, between the first and second valves 304, 306 is higher than ambient, it may indicate that the first valve 304 is leaking. The second valve 306 may be provided, partially as a redundancy, to prevent unintended blowdown of the separator 102. As such, fluid leaking through the first valve 304 may tend to equalize the pressure between the pressure transducer 322 upstream of the first valve 304 and the pressure measured by the pressure transducer 324 downstream of the first valve 304. If the valve 304 is not leaking, the pressures measured by the pressure transducer 324 and the pressure transducer 326 may be approximately equal. If both the first and second valves 304, 306 are leaking, the pressure transducer 326 may read a pressure value approximately equal to that measured by the pressure transducer 322.

In some embodiments, pressure may be injected between the first and second valves 304, 306 to facilitate leak detection. For example, low-flow meters, which may be employed as the sensor (e.g., transducer) 324 downstream of the second valve 306, may not be entirely reliable. Accordingly, a fluid or gas may be injected into the line 307 between the first and second valves 304, 306 when the first and second valves 304, 306 are closed. The pressure may be measured using the pressure transducer 322. If the pressure reduces over time, without opening the first and second valves 304, 306, it may be evidence of a leak in either or both of the valves 304, 306.

If, based on the pressure measurements, the controller 130 determines that leakage is not occurring at 632, no leak mitigation may be called for, and the method 600 may return to awaiting the next blowdown trigger at 610. Otherwise, the method 600 may enter the leak mitigation phase. In this phase, the method 600 may check whether the cycle counter, which was initialized to one in block 628, is less than or equal to a maximum (e.g., two), as at 634. If the cycle counter is less than or equal to the maximum, the method 600 may attempt to wash out the first and/or second valves 304, 306, e.g., in case leakage is occurring because the valve(s) 304, 306 are being prevented from closing fully by sand. Accordingly, for example, the method 600 may include opening the second valve 306 and then opening the first valve 304, as at 636. The method 600 may then include closing the first valve 304 and then closing the second valve 306, as at 638. The method 600 may then proceed to incrementing the cycle counter, as at 640.

The method 600 may then receive the pressure measurements again at 630, and again determine whether a leak is detected at 632, based on these pressure measurements. If a leak is still indicated, the method 600 may determine if the number of leak mitigation cycles, as recorded by the cycle counter, remains less than the maximum at 634. If it is, another round of wash out attempts occurs at 636, 638. This process of washing out and determining if a leak is apparent may repeat for as many times as the counter allows. When the counter exceeds the maximum, the method 600 may determine that the first valve 304 and/or the second valve 306 is/are damaged, and may thus close the shutdown valve 302 and notify the controller 130, as at 614.

Further, when a leak is detected, the method 600 may include tolling blowdown of other separators (in this case, the separators 104 and 106). This may permit the leak mitigation process to proceed without interfering with the sand quantification for (or other aspects of) blowdown of the other separators 104, 106. For example, if leak mitigation is being performed for one separator 102 during a regularly scheduled blowdown for another separator 104, the blowdown of the separator 104 may be postponed. However, there may be a maximum tolling for blowdown of the other separator 104, so as to avoid flooding the separator 104. Thus, if leak mitigation for the separator 102 blowdown takes too long, it may be stopped to allow for blowdown of the other separator 104. Similarly, as noted above, sensor-initiated blowdowns may be queued if multiple are received in a short time period, so that blowdown of two separators does not occur simultaneously, in at least some embodiments.

The foregoing describes detecting leakage in the valves 302-306 of the blowdown valve assemblies 300 of the individual blowdown units 300. However, the method 600 may also include a redundancy measure which may enable checking for system-wide leakage. In particular, the method 600 may include monitoring the sand level in the tank 400 measured by the level sensor 1020 and/or the sand weight in the basket 402 measured by the load cell 404. If either or both of these measurements increase, indicating that sand and/or fluid is being received into the sand disposal unit 126, when none of the blowdown units 120-124 have been signaled to blowdown the separators 102-106, it may be inferred that one or more of the blowdown units 120-124 is permitting leakage. In response, the method 600 may implement the leak mitigation phase, as discussed above, for each of the blowdown units 120-124, further investigate the source of the leakage, shut down the system 100, call for maintenance, or otherwise take actions to avert any potential overfilling of the tank 400.

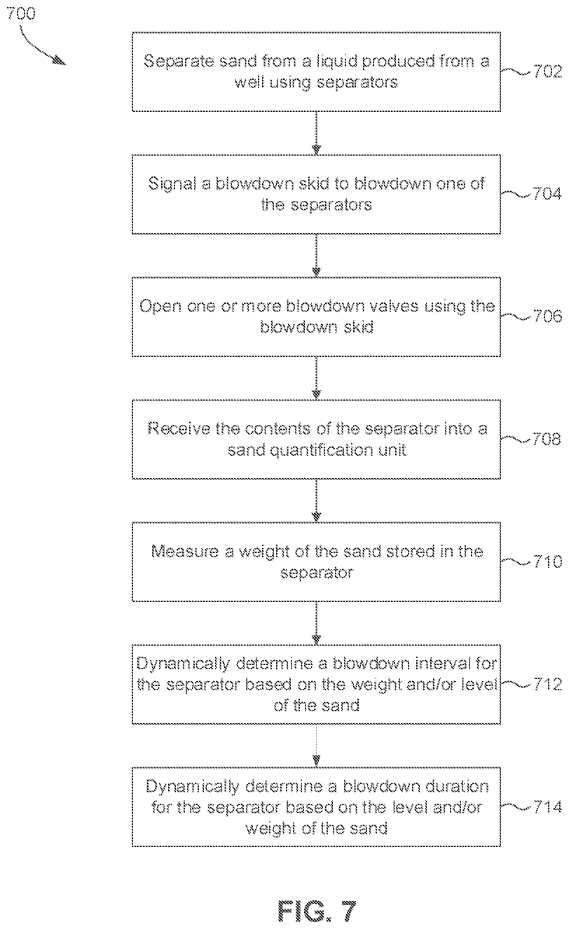

FIG. 7 illustrates a flowchart of a method 700 for automatically controlling a sand separation system, e.g., the sand separation system 100, according to an embodiment. Although a particular order for the steps of the method 700 is described, it will be appreciated that the steps may be executed in a different order and/or steps may be combined or separated.

The method 700 may include separating sand from a fluid produced from a well 108-112 using a plurality of separators 102-106, as at 702. The separators 102-106 may temporarily store the sand therein and provide the separated fluid to a production separator. The method 700 may also include signaling, from a controller 130 to a blowdown unit 120, to blowdown one of the separators (e.g., the separator 102), as at 704. This may be conducted automatically, e.g., at scheduled times or at intervals between blowdowns. In some embodiments, the blowdown may be conducted in response to a sensor-based trigger, e.g., a weight of the separator 102 reaching a particular threshold that indicates it is reaching its sand-storage capacity.

The method 700 may include opening one or more blowdown valves (e.g., the valves 302-306) coupled to a blowdown outlet 206 of the separator 102 using the blowdown unit 120 in response to the signaling, as at 706.

The method 700 may then include receiving the stored contents from the separator 102 into a sand disposal unit 126, as at 708. The method 700 may further include measuring a weight of the sand stored in the separator 102, e.g., as represented by a weight of the sand evacuated therefrom during a blowdown and received into the sand disposal unit 126 or directly by measurement from the load cell 220 positioned in the separator 102. For example, the sand disposal unit 126 may include a basket 402 that receives the fluid from the separators 102-106, and filters the sand therefrom, allowing the fluids to drain into the tank 400. The weight of the basket 402 can then be measured, which provides an indication of how much sand was received during a blowdown procedure.

The method 700 may also include dynamically determining a blowdown interval for subsequent blowdown operations of one or more of the separators 102-106 based in part on the weight of the sand, as at 712. Thus, if sand is being produced from the well 108 more quickly than in previous intervals, the blowdown interval for the separator 102 may be reduced, so as to avoid overfilling the separator 102. On the other hand, if sand is being produced from the well 108 more slowly than in previous intervals, the blowdown interval for the separator 102 may be increased, so as to avoid unnecessary wear of the valves and other components of the separator 102 and/or blowdown unit 120. In other words, the time between blowdowns may be maximized up to a point, so as to avoid filling the separator 102 fully with sand which may carryover between blowdowns, while avoiding blowing down more frequently than necessary.

The method 700 may additionally include dynamically determining a blowdown duration for one or more of the separators 102-106 based in part on the weight and/or level of the sand, as at 714. As noted above, “blowdown duration” refers to the amount of time the blowdown line 107 is open in a given blowdown unit 120-124, e.g., with the valves 302, 304, 306 (and 350, if included) open and prior to closing one or more of the valves 302-306 (and 350). For example, if blowdown operations reveal large amounts of sand being introduced to the tank 400 of the sand disposal unit 126, then the blowdown duration may be lengthened (e.g., holding the valves 302-306/350 open longer) so as to more fully clear the separators 102-106 of sand. If sand amount decreases, blowdown duration may be shortened, e.g., to prevent a well from “gasing out” by emptying the separator 102-106 and blowing mostly gas out the blowdown line 107. If consistent readings come in, a test may be performed to ensure the blowdown duration is sufficient, e.g., by performing a longer than normal blowdown and determining if additional sand, and how much, is received in the sand disposal unit 126. If the sand produced during the test is larger than was received in previous blowdown operations, or received at a relatively consistent rate throughout the blowdown duration, it may indicate that a longer blowdown duration is called for. Further, it will be appreciated that the different separators 102-106 may call for different blowdown durations, as the wells to which they are connected may produce sand at different rates.

In some embodiments, the method 700 may provide leak detection and/or mitigation. For example, the method 700 may include receiving a feedback (e.g., electrical) signal from the blowdown unit 120 that represents that one or more valves 302-306 of the blowdown unit are malfunctioning (e.g., leaking). For example, the signal may be generated by a pressure and/or flow sensor, or two or more sensors in combination. In response to receiving the feedback signal, one or more scheduled blowdown operations for other separators 104-106 may be tolled (e.g., delayed). The leak mitigation efforts may then include attempting to correct operation of the one or more valves 302-306 while the one or more scheduled blowdown operations are tolled.

In an embodiment, the method 700 may include determining that a maximum tolling time has been reached for the one or more scheduled blowdown operations, and in response to determining that the maximum tolling time has been reached, shutting down the separators 102. This may prevent the other separators 104, 106 from overfilling by delaying blowdown thereof too long.

In some embodiments, to detect leakage, rather than (or in addition to) relying on sensor readings related to fluid evacuating as part of the blowdown from the separator 102, the method 700 may include injecting a pressurized fluid between the first and second valves 304, 306 when the first and second valves 304, 306 are closed. The feedback signal may thus be representative of the pressure between the first and second valves 304, 306. As the first and second valves 304, 306 being closed should retain the pressure until one or other are opened, the feedback signal represents that at least one of the first valve 304 or the second valve 306 is malfunctioning when the feedback signal represents a pressure that lowers over time.

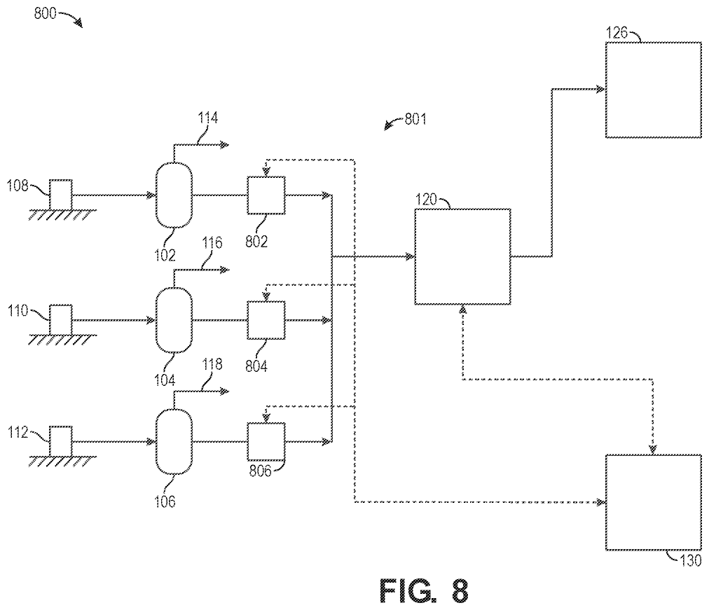

FIG. 8 illustrates a schematic view of a sand separation system 800, according to an embodiment. The system 800 may be similar to the system 100 and may include the separators 102, 104, 106, which may be connected to the wells 108, 110, 112, respectively, as discussed above. In addition, the system 800 may include the blowdown unit 120, control system 130, and sand disposal unit 126.

However, the system 800 may be configured such that the multiple separators 102, 104, 106 (and potentially others) feed the single blowdown unit 120, e.g., instead of feeding separate blowdown units as in FIG. 1. To permit such several-to-one flow from the separators 102, 104, 106 to the blowdown unit 120, a manifold valve assembly 801 may be provided. In particular, the manifold valve assembly 801 may include a plurality of manifold valves 802, 804, 806, e.g., one for each of the separators 102, 104, 106, and positioned downstream thereof. The manifold valves 802, 804, 806 may be controlled via communication with the control system 130, and may be independently operable (e.g., opened, closed, choked, etc.) with respect to one another, responsive to signals from the control system 130. Downstream of the manifold valves 802, 804, 804, the outlet flows from the manifold valves 802, 804, 806 may be combined into a single input into the blowdown unit 120. As such, the valves of the blowdown unit 120, as discussed above, may be configured to control blowdown operations of the several separators 102, 104, 106 (and/or others) by selectively permitting or blocking fluid flow through the separators 102, 104, 106. In at least some embodiments, the manifold valves 802, 804, 806 may be positioned in close physical proximity to the separators 102, 104, 106 so as to reduce the potential sand build up in the line. Accordingly, the manifold valves 802, 804, 806 may be discrete, separate valves positioned near the respective separators 102, 104, 106. In other embodiments, the manifold valves 102, 104, 106 may be provided as a centralized manifold and connected to the separators 102, 104, 106 with sections of pipe coming from each separator 802, 804, 806.

The control system 130 may be configured to maintain the manifold valves 802, 804, 806 in a closed position as a default, as blowdown operations may be intermittent, while normal operation may be generally continuous except when interrupted by blowdown. The control system 130 may determine a blowdown duration and frequency for the individual separators 102, 104, 106 based on historical sand-production rates (e.g., as measured by a load cell within the separator 102, 104, 106, in the sand disposal unit 126, or elsewhere). Further, the controls system 130 may coordinate the blowdown times for the separators 102, 104, 106, e.g., to avoid two separators 102, 104, 106 being blowndown at the same time. For example, the control system 130 may signal to the manifold valve 802 to open, and then for the blowdown unit 120 to execute a blowdown operation, resulting in the blowdown of the separator 102, while the other manifold valves 802, 804, 806 remain closed and prevent blowdown thereof. As such, the manifold valves 802, 804, 806 may permit a selection of which separator 102, 104, 106 to blowdown, while using a single blowdown unit 120.

It will be appreciated that a single system 800 may include several blowdown units, e.g., each connected to two or more separators, and all or some of these blowdown units may be controlled by the control system 130 and/or one or more additional control systems 130. In such cases, manifold valves may be provided for each of the separators, e.g., to permit the control system 130 to select which separator to blowdown, so as to coordinate blowdown timing as between the different separators, taking into consideration leak mitigation, etc., as discussed above.

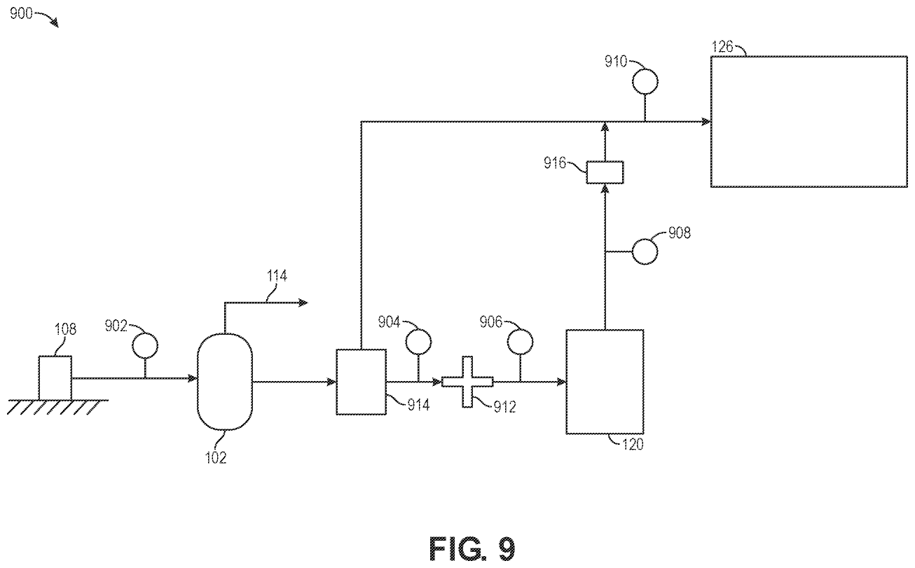

FIG. 9 illustrates a schematic view of a sand separation system 900, according to an embodiment. The system 900 may be similar to the system 100. The system 900 may include one or more separators, e.g., the separator 102, which may be connected to the well 108. In addition, the system 800 may include the blowdown unit 120 and the sand disposal unit 126. Although not shown, the system 900 includes a control system (e.g., the control system 130), which may communicate with sensors and actuators to control the system 900.

The system 900 may include one or more pressure sensors, e.g., pressure sensors 902, 904, 906, 908, 910 as shown. The system 900 may also include a debris catcher 912, a bypass valve system 914, and an adjustable choke 916 that is downstream of the blowdown unit 120. The adjustable choke 916 may be provided to mitigate the erosion of the valve train within the blowdown unit 120. For example, the adjustable choke 916 may reduce the pressure drop across the blowdown unit 120, e.g., such that the blowdown unit 120 does not step the pressure down from wellhead to ambient, but to some intermediate pressure upstream of the adjustable choke 916. The adjustable choke 916 may then step the pressure down to ambient.

Having this choke 916 also allows the operator (and/or control system) to finely tune the blowdown duration. They can set this time, and then adjust to choke 916 to allow more or less flow through the system 900 during the time the blowdown unit 120 permits blowdown (e.g., the time that the first valve 302 of FIG. 3A is open). This provides a tool to combat “gas out”, a situation in which the separator 102 is fully evacuated of liquid and large amounts of gas begin to flow through the system, which may surge the well 108.

It will be appreciated that the choke 916 may be used in embodiments that do not include a debris catcher 912, and the debris catcher 912 may be used in embodiments that do not include a choke 916.

The bypass valve system 914, which may include one or more bypass valves, adjustable chokes, etc., may be positioned between the separator 102 and the blowdown unit 120. The bypass valve system 914 may be coupled to the sand disposal unit 126, and may normally permit fluid to flow from the separator 102 to the debris catcher 912, but may be modulated to redirect fluid directly to the sand disposal unit 126, bypassing the blowdown unit 120, e.g., in response to signals from the control system 130 (e.g., FIG. 3A) or manually by operation of a user.

The debris catcher 912 may also be between the separator 102 and the blowdown unit 120, e.g., downstream of the bypass valve system 914. The pressure sensor 902 may be positioned between the wellhead 108 and the separator 102. The pressure sensor 904 may be positioned between the separator 102 or downstream thereof on outlet 114 (e.g., FIG. 1) and the debris catcher 912. In other embodiments, the pressure sensor 904 may be placed in any position upstream of the debris catcher 912. In some embodiments, the pressure sensor 904 may be redundant to the pressure sensor 902 and could be omitted. The pressure sensor 906 may be positioned between the debris catcher 912 and the blowdown unit 120. In some embodiments, the pressure sensor 906 may be provided as part of the blowdown unit 120 (e.g., pressure transducer 322 of FIG. 3A). The pressure sensors 908 may be positioned between the blowdown unit 120 and the adjustable choke 916. The pressure sensor 910 may be positioned between the adjustable choke 916 and the sand disposal unit 126.

In some embodiments, during initial flowback, significant amounts of solids are produced from the well 108. As this may be the first time the well 108 is opened, pieces of completions devices, plug parts, large particles of debris, etc., that are left in the well from the completions and drilling processes can be brought to surface. The trash can be dense metal, and large mass. The separator 102 separates these large pieces and captures them in its accumulator. When the blowdown unit 120 performs a blowdown of the separator 102, these pieces of debris or “trash” are pushed through the primary blowdown valve, which can damage the primary blowdown valve or prevent the primary blowdown valve from functioning correctly, e.g., become packed off, stuck open or closed, etc.

Accordingly, the debris catcher 912 may be provided to prevent such separated trash from reaching the blowdown unit 120 and damaging the valves therein. As shown, the debris catcher 912 may be a ball catcher device. The debris catcher 912 may have a removable filter element (e.g., a metal screen) that is received perpendicular to the direction of flow, which may be removed when it is packed off (fouled with trash).

The pressure sensors 902-910 may be configured to provide signals that the control system 130 uses to determine when the debris catcher 912 is packed off. For example, when not under blowdown conditions, the pressure sensor 902 may record measurements approximately equal to wellhead pressure. The pressure sensor 904 may read slightly lower pressures, as the separator 102 may produce a small amount of pressure drop, and the pressure sensor 906 may read a generally equal pressure. The pressure sensors 908 and 910 may read equal, generally atmospheric pressures.

During a normal blowdown operation, the pressure sensors 902 and 904 may be generally unchanged, observing wellhead pressure and slightly below wellhead pressure, respectively. Further, pressure sensors 904 and 906 may read a generally consistent, equal pressure. Further, the pressure recorded by the pressure sensor 908 may be generally higher than the pressure recorded at the pressure sensors 910, as the adjustable choke 916 may produce a pressure drop in the fluid flowing therethrough from the blowdown unit 120 to the sand disposal unit 126 during the blowdown.

When the debris catcher 912 is plugged, the pressure read by the pressure sensor 906 may be substantially lower than what is read during the normal blowdown operation. For example, in normal operations, the pressure read by pressure sensor 906 may be between about 55% and about 65% of the wellhead pressure. During a blowdown, if the pressure read by the pressure sensor 906 is outside of this range, e.g., below the range, the debris catcher 912 may be plugged. In addition, the pressure sensors 904, 908, 910 may vary in pressure readings from a normal blowdown operation, as the total flow allowed through the debris catcher 912 is reduced. Accordingly, at least partially in response to the change (e.g., reduction) in pressure sensed by the pressure sensor 906 downstream of the debris catcher 912, the control system 130 (e.g., FIG. 3A) connected thereto may determine that the debris catcher 912 is fouled. The control system 130 may then take an appropriate mitigation action, such as stopping blowdowns with unit 120, engaging the bypass valve 914 to route blowdown fluid directly to the sand disposal unit 126, scheduling maintenance, producing a visual or audible warning, etc.

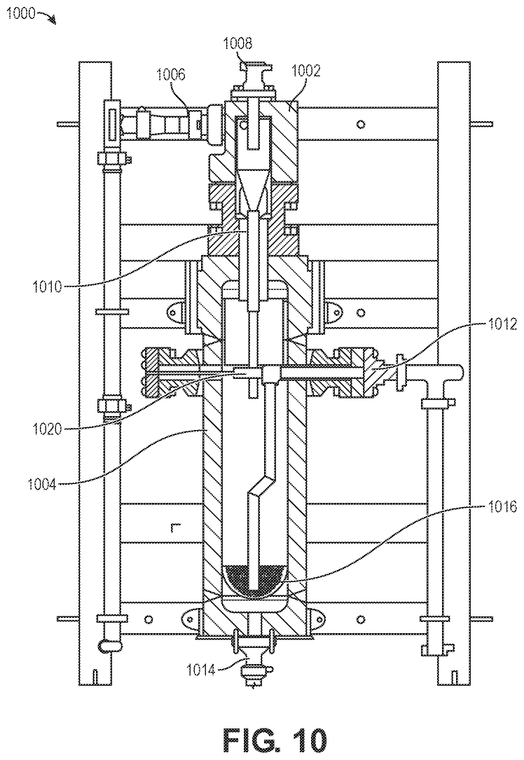

FIG. 10 illustrates a side, cross-sectional view of a separator 1000 of any one of the foregoing systems, according to an embodiment. For example, the separator 1000 may be an embodiment of one or more of the separators 102-106 of FIG. 3A. The separator 1000 may include a cyclone 1002 and an accumulator 1004, which may be positioned below the cyclone 1002 and configured to receive solids (e.g., particulate matter such as sand) that is separated from a flow of fluid in the cyclone 1002. An inlet 1006 may provide the particulate-laden fluid to the cyclone 1002, and a fluid outlet 1008 may receive the fluid flow from the cyclone 1002. The separated solids (and some of the fluid) may drop out of the cyclone 1002 via a solids outlet 1010.

A blowdown outlet 1012 and a drain 1014 may be coupled to the accumulator 1004. During blowdown operations, sand and other solids 1016 may be evacuated from the accumulator 1004 via the blowdown outlet 1012, as lower pressure downstream draws a slurry of the solids 1016 and liquid from within the accumulator 1004 out through the blowdown outlet 1012. The accumulator 1004 also contains a level sensor 1020 therein. The level sensor 1020 may be a load cell measuring the weight of the sand, a density or viscosity measurement device, and/or a device that measures an electromagnetic tomography. Accordingly, the level sensor 1020 may provide a signal that permits a binary determination of whether or not sand has reached the level sensor 1020, as this may represent a measurable change in density and/or viscosity surrounding the level sensor 1020, or the weight of the sand in the accumulator 1004. The level sensor 1020 may be positioned toward the top of the accumulator 1004, such that solids reaching the level sensor 1020 may provide a trigger for the control system 130 (e.g., FIG. 3A) to initiate a blowdown.

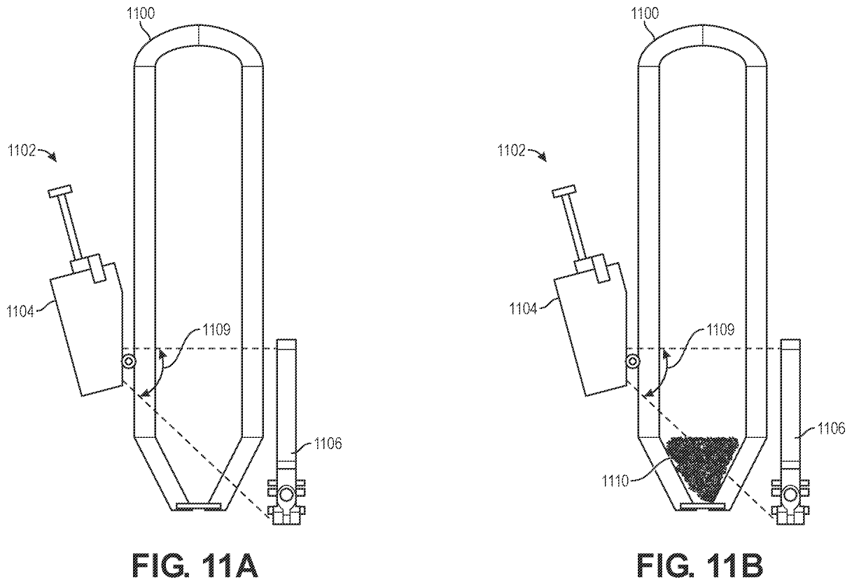

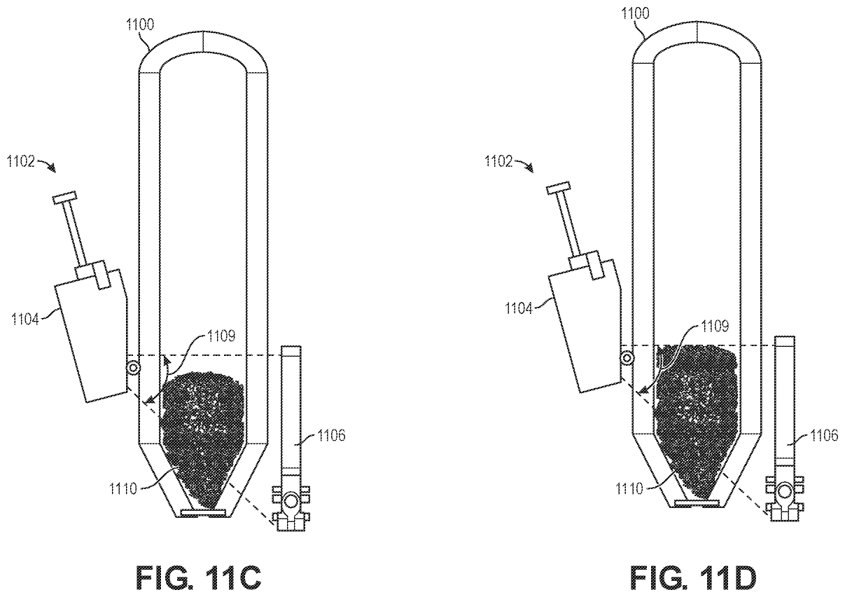

FIGS. 11A, 11B, 11C, and 11D illustrate side, schematic views of an accumulator 1100 for a separator, which may be provided with an external sand-level detector 1102, according to an embodiment. The external sand-level detector 1102 may be a nuclear emitter 1104 and receiver 1106 combination. The detector 1102 may employ nuclear densitometry to determine sand level within the accumulator 1100, without requiring a penetration of the pressure vessel or exposing the detector 1102 to the high-pressure environment therein. In particular, the nuclear emitter 1104 may be placed on one lateral side of the accumulator 1100, and the receiver 1106 may be placed on the opposite lateral side of the accumulator 1100. As sand builds up in the accumulator 1100, the sand shields the receiver 1106 from the radiation emitted by the emitter 1104. This reduction can be measured.

In at least some embodiments, the detector 1102 may provide an analog scale that may provide indications of potentially several sand levels, as the sand fills the accumulator 1100 during use. For example, the receiver 1106 may be formed as a long rod, as shown. The emitter 1104 may emits radiation on, e.g., a 45-degree field 1109. As the sand accumulates (e.g., proceeding from FIGS. 11A to 11B, 11C, and 11D, sand 1110 is shown accumulating), more of the field is obstructed by the sand 1110, and less radiation reaches the receiver 1106.

In another embodiment, a smaller, point source may be employed as the emitter 1104, with a more concentrated “beam of radiation” that would pass through the vessel to the receiver 1108 (in this embodiment, a point receiver rather than a long rod). When sand built up and breaks the beam of radiation, the detector 1102 would signal to the controls system 1130 that the accumulator 1100 is full (or nearly full).

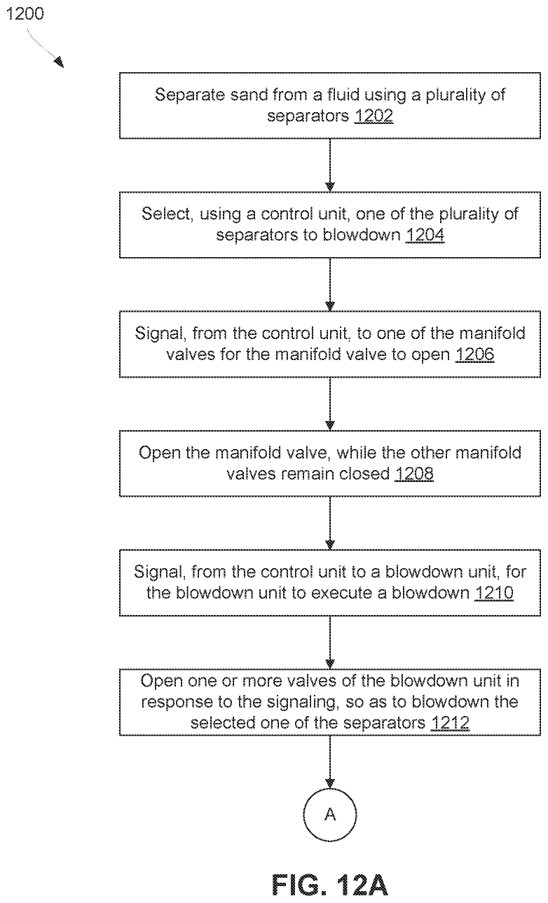

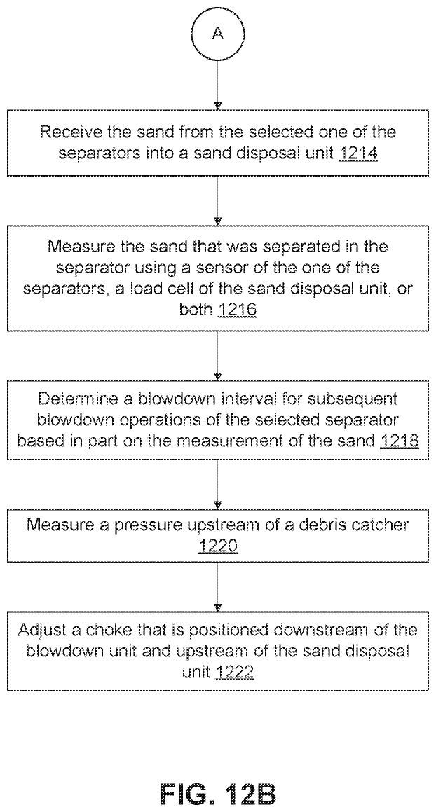

FIGS. 12A and 12B illustrate a flowchart of a method 1200 for operating a sand separation system, e.g., any one or a combination of the systems 100, 800, 900 discussed above, according to an embodiment. The method 1200 may include separating sand from a fluid using a plurality of separators 102-106, as at 1202. The separators 102-106 each temporarily store the sand therein, e.g., in an accumulator (e.g., the accumulator 1004 of FIG. 10). A plurality of manifold valves 802-806 are each coupled to a respective one of the separators 102-106, e.g., in the configuration of FIG. 8.

The method 1200 may also include selecting, using a control unit (or control “system”) 130, one of the plurality of separators (e.g., the separator 102) to blowdown, as at 1204.

The method 1200 may further include signaling, from the control unit 130, to one of the manifold valves (e.g., valve 802), the one of the manifold valves being coupled to the separator 102, for the manifold valve 802 to open, as at 1206.

The method 1200 may include opening the manifold valve 802, as at 1208, while the other manifold valves 804, 806 remain closed.

The method 1200 may also include signaling, from the control unit 130 to a blowdown unit 126, for the blowdown unit 120 to execute a blowdown, as at 1210.

The method 1200 may include opening one or more valves (e.g., valves 302, 304, 306) of the blowdown unit 120 in response to the signaling, so as to blowdown the selected one of the separators 102, as at 1212.

The method 1200 may include receiving the sand from the selected one of the separators into a sand disposal unit 126, as at 1214. The sand passes through the manifold valve 802 that is opened and through the blowdown unit 126 (via the open valves 302, 304, 306 thereof).

The method 1200 may also include measuring the sand that was separated in the separator 102 using a sensor of the one of the separators, a load cell of the sand disposal unit, or both, as at 1216. In at least some embodiments, the control unit 130, e.g., as part of the method 1200, may determine that it is time to execute a blowdown operation based on measuring the sand that was separated in the one or more separators 102 using the sensor of the one or more separators. For example, the sensor may be the level sensor 1020 and/or the nuclear detector 1102. As noted above, the nuclear detector 1102 may include the nuclear emitter 1104 that emits a field of radiation 1109. Thus, the method 1200 may include detecting a level of the sand in the accumulator based on the sand obstructing at least a portion of the field of radiation, e.g., as part of the measuring at 1216.

In another embodiment, measuring the sand that was separated in the separator uses the level sensor 1020 positioned at least partially in an accumulator 1004 of the separator 1000 (e.g., a representative example of the separator 102). The level sensor 1020 may thus provide a signal representing whether or not a sand level in the accumulator has reached the level sensor 1020.

The method 1200 may include determining a blowdown interval for subsequent blowdown operations of the selected separator 102 based in part on the measurement of the sand, as at 1218. The blowdown interval may include a safety interval, which may be determined based on collected production information. The safety interval may be set as a function of sand production rate and accumulator capacity, and may thus be set to avoid overfill in the case that the level sensor fails to trigger. That is, the safety interval may be set at a time that is less than the accumulator capacity (the amount of sand that can be contained in the separator before an overfill) divided by recent/past sand production rate. The method 1200 may thus determine that it is time to blowdown the separator based on either the level sensor determining that the sand has reached a blowdown/trigger level, or at the expiration of the safety interval since the last blowdown of the separator, whichever comes first.

For example, a previous blowdown quantification may show that a well is producing 100 kg/hr of sand. The internal level sensor is set at an elevation at which the accumulator contains 200 kg of sand. Therefore, the level sensor 1020 or another may be expected to trigger within the next two hours of operating time. By comparison, the accumulator 1004 holds 400 kg of sand. Because sand production rates can vary, a safety interval may be set to force the blowdown at some time after the trigger, but before the time at which overfill may be expected based on recent production rates (e.g., the 100 kg/hr). In this example, three hours to force a blowdown may be a suitable safety interval, to ensure that the 400 kg accumulator is not overfilled, although different operators may select different safety intervals. Accordingly, using such a safety interval, the separator(s) may be blowndown and emptied every three hours, or upon the level sensor being triggered, whichever comes first.

In an embodiment, the method 1200 may include measuring a pressure downstream of a debris catcher, the debris catcher positioned between the separator and the blowdown unit, as at 1220. The method 1200 may also include determining that the pressure measured upstream of the debris catcher is out of a predetermined range (e.g., below a certain threshold percentage of wellhead pressure, e.g., less than about 70%, less than about 65%, less than about 60%, or less than about 55% thereof). In response to determining that the pressure measured upstream of the debris catcher 912 is out of the predetermined range, the method 1200 may include the control unit 130 executing one or more mitigation actions in response to the debris catcher being plugged. The mitigation actions may include opening a bypass valve that routes fluid to the sand disposal unit and not to the blowdown unit or the debris catcher, or cleaning out a filter screen of the debris catcher.

At 1222, the method 1200 includes adjusting a choke 916 that is positioned downstream of the blowdown unit 120 and upstream of the sand disposal unit 126, to tune the blowdown operation and reduce a pressure drop across the blowdown unit 126, as described above.

As used herein, the terms “inner” and “outer”; “up” and “down”; “upper” and “lower”; “upward” and “downward”; “above” and “below”; “inward” and “outward”; “uphole” and “downhole”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method for operating a sand separation system, comprising:
separating sand from a fluid using a plurality of separators, wherein the separators each temporarily store the sand therein, and wherein a plurality of manifold valves are each coupled to a respective one of the separators;
selecting, using a control unit, one of the plurality of separators to blowdown;
signaling, from the control unit, to one of the manifold valves, the one of the manifold valves being coupled to the selected one of the plurality of separators, for the one of the manifold valves to open;
opening the one of the manifold valves, wherein the other manifold valves remain closed;
signaling, from the control unit to a blowdown unit, for the blowdown unit to execute a blowdown;
opening one or more valves of the blowdown unit in response to the signaling, so as to blowdown the selected one of the separators;
receiving the sand from the selected one of the separators into a sand disposal unit, wherein the sand passes through the manifold valve that is opened and through the blowdown unit; and
measuring the sand that was separated in the one of the separators using a sensor of the one of the separators, a load cell of the sand disposal unit, or both.

2. The method of claim 1, further comprising determining that it is time to execute a blowdown operation based on measuring the sand that was separated in the one or more separators using the sensor of the one or more separators.

3. The method of claim 2, wherein determining that it is time to execute a blowdown operation further comprises:
determining a maximum quantity of sand before an overfill of the separator based on past sand production rate;
setting a safety interval between blowdowns that is less than the maximum quantity of sand before an overfill divided by the past sand production rate; and
determining that it is time to execute the blowdown operation based on the sensor measuring a certain amount of sand in the separator, or upon expiration of the safety interval, whichever comes first.

4. The method of claim 1, further comprising determining a blowdown interval for subsequent blowdown operations of the selected separator based in part on the measurement of the sand.

5. The method of claim 1, wherein measuring the sand that was separated in the separator comprises using the sensor of the separator, and wherein the sensor of the separator comprises a nuclear emitter and receiver that are positioned outside of an accumulator of the separator.

6. The method of claim 5, wherein the nuclear emitter emits a field of radiation, and wherein the method comprises detecting a level of the sand in the accumulator based on the sand obstructing at least a portion of the field of radiation.

7. The method of claim 1, wherein measuring the sand that was separated in the separator comprises using the sensor of the separator, wherein the sensor of the separator comprises an density, acoustic, or electromagnetic tomography measurement sensor positioned at least partially in an accumulator of the separator, and wherein acoustic measurement sensor provide a signal representing whether or not a sand level in the accumulator has reached the acoustic measurement sensor.

8. The method of claim 1, further comprising:
measuring a pressure downstream of a debris catcher, the debris catcher positioned between the separator and the blowdown unit;
determining that the pressure measured downstream of the debris catcher is out of a predetermined range; and
in response to determining that the pressure measured downstream of the debris catcher is out of the predetermined range, executing one or more mitigation actions in response to the debris catcher being plugged.

9. The method of claim 8, wherein the pressure measured downstream of the debris catcher is out of the predetermined range when the pressure measured upstream of the debris catcher is less than 65% of a pressure measured at a wellhead coupled to the separator.

10. The method of claim 9, wherein the pressure measured downstream of the debris catcher is out of the predetermined range when the pressure measured upstream of the debris catcher is less than 55% of the pressure measured at the wellhead coupled to the separator.

11. The method of claim 8, wherein the one or more mitigation actions comprise at least one of:
opening a bypass valve that routes fluid to the sand disposal unit and not to the blowdown unit or the debris catcher; or
cleaning out a filter screen of the debris catcher.

12. The method of claim 1, further comprising adjusting a choke that is positioned downstream of the blowdown unit and upstream of the sand disposal unit, to tune the blowdown and reduce a pressure drop across the blowdown unit.

13. A sand separation system, comprising:
a plurality of separators in fluid communication with one or more wells and configured to receive a mixture comprising sand and fluid therefrom, and to separate at least some of the sand from the fluid, wherein the separators temporarily store the sand that is separated from the fluid;
a blowdown unit in communication with the separators, wherein the blowdown unit is configured to permit the sand stored in the separator to exit the separator;
a manifold valve assembly positioned between the plurality of separators and the blowdown unit, wherein the manifold valve assembly is configured to control which of the separators is in fluid communication with the blowdown valve assembly;
a sand disposal unit configured to receive the sand that is stored in the separators between blowdown operations; and
a control system in communication with the blowdown unit, the sand disposal unit, and the manifold valve assembly, wherein the control system is configured to initiate the blowdown operations by opening one of the manifold valves and opening the blowdown unit valve assembly, so as to blowdown a selected one of the plurality of separators.

14. The sand separation system of claim 13, wherein the control system is configured to determine a blowdown duration for each one of the separators, and to operate the manifold valves so as to blowdown each of the separators for the respective blowdown duration, and to prevent two of the separators from being blowndown at the same time.

15. The sand separator system of claim 13, further comprising an adjustable choke valve positioned downstream of the blowdown unit and upstream of the sand disposal unit, wherein the adjustable choke is configured to be adjusted in response to signals from the control system or manually by an operator so as to tune a blowdown operation of at least one of the separators by modulating the adjustable choke.

16. The sand separator system of claim 13, wherein the separator comprises a sand level sensor configured to determine a level of sand within the separator, and wherein the control system is configured to initiate a blowdown at least partially in response to a measurement taken by the sand level sensor.

17. The sand separator system of claim 16, wherein the sand level sensor comprises a density, acoustic, or electromagnetic tomography sensor coupled to an accumulator of the sand separator.

18. The sand separation system of claim 16, wherein the sand level sensor comprises a nuclear emitter and a receiver configured to detect radiation emitted by the nuclear emitter, and wherein the control system is configured to determine a sand level in the separator based at least in part on the radiation detected by the receiver.

19. The sand separation system of claim 13, further comprising a pressure sensor positioned downstream of a debris catcher, the pressure sensor being in communication with the control system, wherein the control system is configured to determine that the debris catcher is fouled with trash based at least in part on a pressure measurement taken by the pressure sensor of fluid flow upstream of the debris catcher and downstream of the separator.

20. The sand separation system of claim 19, wherein the control system is configured to infer that the debris catcher is fouled in response to the pressure sensor reading a pressure of less than about 55% of a well pressure measured in a well to which at least one of the separators is fluidly connected.

21. The sand separation system of claim 19, wherein the control system is configured to infer that the debris catcher is fouled in response to the pressure sensor reading a pressure of less than about 65% of a well pressure measured in a well to which at least one of the separators is fluidly connected.

22. The sand separator system of claim 13, wherein the blowdown unit comprises a blowdown valve assembly.
